(19) United States
(12) Patent Application Publication
(10) Pub. No.: US 2009/0018926 A1
(43) Pub. Date: Jan. 15, 2009

(54) Web-based virtual clothing coordinator including personal mannequin with customer-directed measurements, image modification and clothing

(76) Inventor: Divina Buehlman, Laguna Hills, CA (US)

Correspondence Address: STOUT, UXA, BUYAN & MULLINS LLP, 4 VENTURE, SUITE 300, IRVINE, CA, 92618, US

(21) Appl. No.: 11/879,007

(22) Filed: Jul. 13, 2007

(51) Int. Cl. G06Q 30/00

(52) U.S. Cl. 705/26

(57) ABSTRACT

A web-based clothing coordinator interacts with a customer through a computer network. Precision measurements taken from a body of a subject are compared with corresponding measurements taken from clothing offered for sale, and an exactness-of-fit is determined and communicated to the customer

### BACKGROUND OF THE INVENTION

1. Field of the Invention

The present invention relates generally to computers and, more particularly, to computer systems for generating and maintaining databases for users and to apparatuses and methods for promoting clothing products.

2. Description of Related Art

Purchasing clothing can be a time consuming and even stressful activity for some shoppers. Traveling to a clothing store, interacting (sometimes competing) with other shoppers, taking chances on getting a friendly, helpful clerk, and other inconveniences, may combine to make a shopping for clothing unpleasant. Additionally, some shoppers may have negative feelings about their own body shape which may render shopping particularly difficult.

Before about the middle of the 20^{th} century, when much clothing was handmade, an adjustable clothing form was sometimes used by seamstresses and/or tailors to design clothing to fit a particular person. The person's measurements, for example, bust/chest, waist, and hip circumferences, could be used to adjust a size of, for example, a dress or suit coat according to those measurements.

The inconvenience of shopping for clothing in today's environment leaves room for innovative improvement.

### SUMMARY OF THE INVENTION

An embodiment of the present invention is implemented as a web-based virtual clothing coordinator comprising an input adapted to receive input data through a computer network from at least one customer operating a client computer.

In one aspect, the web-based virtual clothing coordinator includes modeling software adapted to effectuate accessing, updating or generating a first vector of subject-customized numerical descriptors describing at least a portion of a body of a subject, the first vector being constructed according to the input data received from the customer. The input data may include a plurality of precision numerical measurements taken from the body of the subject.

The embodiment, further, comprises a database accessible to the client computer, the database comprising a plurality of records, each of the records corresponding to a precision-measured clothing item and comprising a second vector of detailed dimensional descriptors that is unique to that precision-measured clothing item.

The embodiment still further comprises a server configured to receive from the customer a selection of one of the precision-measured clothing items, the selected precision-measured clothing item being described by one of the second vectors of detailed dimensional descriptors that is unique to that selected precision-measured clothing item.

The server is configured to generate information describing an exactness-of-fit of the selected precision-measured clothing item to a portion of the body of the subject on which the selected precision-measured clothing item is designed to fit. The information may be generated according to a comparison of five or more of subject-customized numerical descriptors of the first vector to a corresponding five or more of the detailed dimensional descriptors of the second vector.

While the apparatus and method have or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112.

Any feature or combination of features described herein are included within the scope of the present invention provided that the features included in any such combination are not mutually inconsistent as will be apparent from the context, this specification, and the knowledge of one skilled in the art. In addition, any feature or combination of features may be specifically excluded from any embodiment of the present invention. For purposes of summarizing the present invention, certain aspects, advantages and novel features of the present invention are described. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE DRAWINGS

FIG. 1 is a schematic diagram of a network configuration including a server and a plurality of clients;

FIG. 2 is a block diagram of an apparatus that may implement a method of the present invention;

FIG. 3 is a conceptual diagram of an example of a file of records created and maintained in a database of the apparatus of FIG. 2;

FIG. 4 is a diagram of a body vector and clothing vectors;

FIG. 5A is a portion of a flow chart illustrating one implementation of a method in accordance with the present invention;

FIG. 5B is a continuation of the flow chart of FIG. 5A; and

FIG. 6 is a flow chart of an implementation of an alternative method of the present invention.

The present invention, together with additional features and advantages thereof, may best be understood by reference to the following description taken in connection with the accompanying illustrative drawings.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale. In reference to the disclosure herein, for purposes of convenience and clarity only, directional terms, such as, top, bottom, left, right, up, down, over, above, below, beneath, rear, and front, are used with respect to the accompanying drawings. Such directional terms should not be construed to limit the scope of the invention in any manner.

Although the disclosure herein refers to certain illustrated embodiments, it is to be understood that these embodiments are presented by way of example and not by way of limitation. The intent of this disclosure, while discussing exemplary embodiments, is that the following detailed description be construed to cover all modifications, alternatives, and equivalents of the embodiments as may fall within the spirit and scope of the invention as defined by the appended claims. It is to be understood and appreciated that the process steps and structures described herein do not cover a complete process flows. The present invention may be practiced in conjunction with various techniques that are conventionally used in the art, and only so much of the commonly practiced process steps are included herein as are necessary to provide an understanding of the present invention.

In accordance with one aspect of the present invention, a method of on-line shopping, using a computer processor of a web-based virtual clothing coordinator to promote sales, includes a step of receiving precision measurements from a user followed by a step of providing an image of a personal mannequin that embodies unique physical measurements of the user. The image of the personal mannequin may be presented on a display of a computer that may access the web-based virtual clothing coordinator via the Internet.

The method can include two optional steps of requesting the user to select a category of clothing to be applied to the image of the personal mannequin, and receiving a selection from the user. The method may continue with a step of requesting the user to select a type of clothing (e.g., from the selected category) and, optionally, to apply the type of clothing to the personal mannequin in areas of the personal mannequin where, and/or in a manner how, the user wishes to have the selected type of clothing applied.

For example, the user may click and drag a hat onto the head area and then alter it to have a preferred orientation such as high-up, well-forward, leaning to the left, etc., or may, as another example, apply pants high-up or lower-down relative to the waist line. As other examples, the item of clothing may be automatically applied in a standard or conventional orientation, after which the user may enter a mode wherein he or she may, for example, alter the orientation of the clothing item. The applying can be followed by or coupled with a step of altering the appearance of the personal mannequin, based upon the user's applications of the type and (optional) customized orientation of clothing to the personal mannequin.

A step of requesting the user to finalize the altered personal mannequin, now with clothing applied, when the user has finished applying clothing items to the personal mannequin may be followed by a step of displaying a price list of various clothing products that are presently applied to the personal mannequin. In one embodiment, at least some of the clothing items are offered for sale on-line.

The step of requesting the user to select a category of clothing to be applied to the captured image can include a step of requesting the user with a multi-media (e.g., video) presentation to select a category of clothing to be applied to the personal mannequin. The step of requesting the user to select a type of clothing (e.g., from the selected category) and to apply the type of clothing to the personal mannequin can include a step of requesting the user with a multi-media (e.g., video) presentation to select a type of clothing (e.g., from the selected category) and to apply the type of clothing by touching (e.g., by clicking with a pointing device) an image of the personal mannequin in an area or areas of the personal mannequin where the user wishes to have the selected type of clothing applied. The step of requesting the user to finalize the altered personal mannequin can include a step of requesting the user via a multi-media (e.g., video) presentation to finalize the clothed personal mannequin when the user has finished applying clothing items to the personal mannequin.

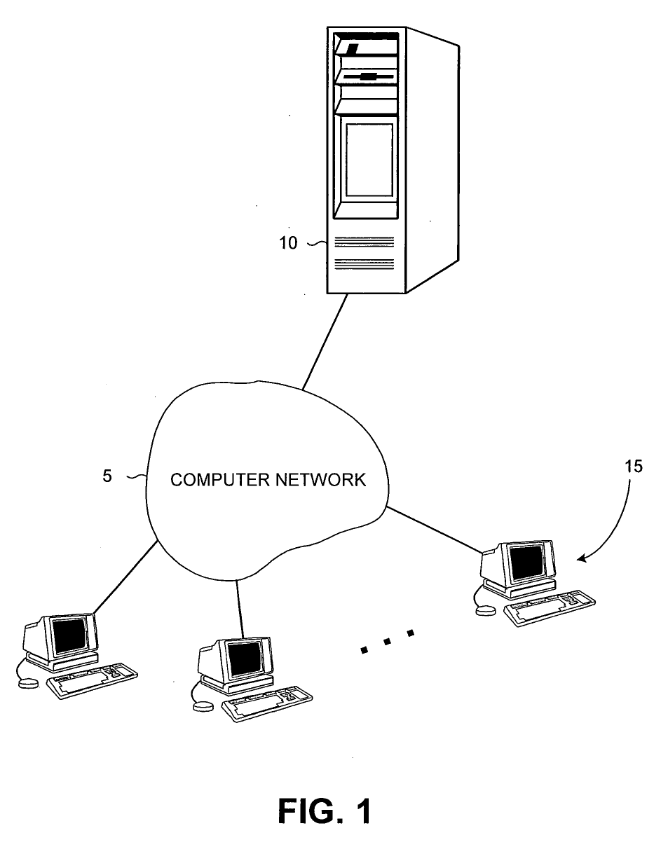

Referring now to FIG. 1, there is shown a schematic diagram of a network 5 in accordance with the present invention. The network 5 can be an Internet, Intranet, local area network, or any other medium for allowing at least one server 10 to communicate with at least one client 15. In the exemplary illustration, a server 10 communicates through the network 5 with a plurality of clients 15. The basic architectures of the server 10 and the clients 15 are preferably those well known in the art, such as, for example, computers having Intel Corporation (Santa Clara, Calif.) microprocessors and running Microsoft Corporation (Redmond, Wash.) Windows or Windows NT operating systems. The network 5 may include hubs, routers and other network devices (not shown).

By way of definition, a “server,” refers to a computer that controls access to file and disk resources, such as multi-media (e.g., video) presentations, on a network, and provides security and synchronization on the network through a network operating system. The server hardware and/or software may provide services to other hardware and/or software. A “client” refers to a client computer that routes user (e.g., customer) commands either to a local operating system or to a network interface adapter for processing and transmission on the network 5. A client may function as a server by including appropriate software, and may be for example, an archive server or a communication server.

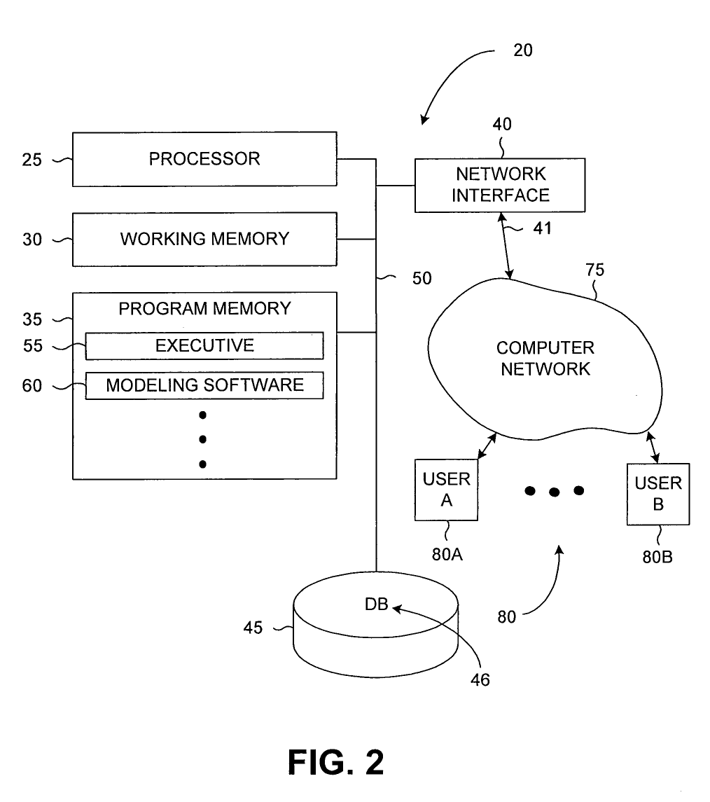

FIG. 2 is a block diagram of one particular implementation of an apparatus adapted to perform functions according to the present invention. The illustrated embodiment comprises a server 20 including at least one processor 25, (some embodiments may employ multiple processors) working memory 30, program memory 35, and a network interface 40 having an input port 41. The illustrated embodiment further comprises a database 46, which may be stored, for example, on a hard disk 45, and a system bus 50 that communicatively interconnects the aforementioned elements. The program memory 35 may have stored therein software modules including an executive software module 55, a modeling software module 60, and other software modules (not shown) including, for example, a database software module, an accounting software module, an operating system software module, and the like. The server 20 in the illustrated embodiment may communicate with client computers 80, e.g., client computer 80A or client computer 80B, through a computer network 75 and may receive input data from one of the client computers 80 through, for example, the input port 41. The computer network 75 may comprise, for example, an Internet, an Intranet, a local area network, or the like.

According to one exemplary operating mode of the server 20 shown in FIG. 2, the server 20 is adapted to receive input through the computer network 75 from at least one customer operating one of the client computers, such as client computer 80A. The input may be selected, for example, from a list of possible commands communicated by the server 20 to the customer subsequent to the customer's signing-in to a web site supported by the server 20. According to a typical embodiment, the customer may click on a command such as “CREATE PERSONAL MANNEQUIN.” Subsequently, the server 20 may communicate with the customer through the network 75 and the client computer to receive additional commands through which the server 20 receives, for example, unique physical dimensions and measurements of the customer.

Examples of precision numerical measurements that may be generated from the unique physical dimensions of the subject may include, by way of illustration, but not by way of limitation, height, weight, age, gender, and ethnicity, the latter three being included, by definition, only if computationally used to provide unique-physical-dimension information useful to help generate the precision numerical measurements (for example, one or more of them may contribute to size/proportion information or extrapolation information). Further examples of precision numerical measurements that may be generated from the unique physical dimensions of the subject may include bust size, bust circumference, waist size, waist circumference, hip size, hip circumference, among others. Alternative embodiments of a personal mannequin (e.g., a virtual mannequin), further, may comprise details such as hair color, color of eyes, complexion and the like.

Precision numerical measurements may further include, for example, what may be referred to herein as circumference modeling or progressing measurements, defined as circumference measurements performed at multiple locations (e.g., three inches apart) between two points along a length of one or more of: the hands, feet, arms, legs, neck, and head, of the subject. As an example, circumference modeling measurements may be taken from the underarms to a point below the navel, and/or may be taken in the form of multiple head circumference modeling measurements likewise performed at predetermined locations (e.g., ½ inch apart) from top-to-bottom and/or from left-to-right and/or from front to back of the head. Precision numerical measurements may be made on other parts or subparts of the subject, such as, for example, forearms, wrists, ears, upper legs, fingers, and so on,

Precision numerical measurements may also include, for example, what may be referred to herein as point-to-point modeling measurements, defined as distance measurements between two points along a length of one or more of: the hands, feet, arms, legs, neck, two (e.g., two, more, or all) circumference modeling measurements, and head, of the subject. Such precision numerical measurements as well as others that will occur to one skilled in the art may be made in connection with, for example, arm length (measured, for example, from a backbone to a bony prominence on a wrist) torso length (measured, for example, from a nape of a neck to a waist), and shoulder width (measured from an outer limit of a left shoulder to a right shoulder).

In accord with one embodiment, the user may be prompted to upload a photograph of a particular body part, which photograph may be incorporated into the personal mannequin. For example, the user may scan his or her face, submit the scan to the server, and request that the scan be incorporated into a model of the head of the personal mannequin.

A modeling software module 60, which may be stored, for example, in program memory 35, may cause the server 20 to create a three-dimensional model of a personal mannequin constructed according to the commands received from the customer. It should be understood that such creation is within the current capacity of the imaging art. Current media have created virtual movie characters that are sufficiently realistic so as to create an illusion of reality. Practitioners in this field of endeavor will find the creation and incorporation of a detailed three-dimensional personal mannequin to be achievable using existing processing hardware, software, and related algorithms and components. According to one aspect of the present invention, the personal mannequin may not correspond to one or more of (a) the precision numerical measurements and (b) entered details such as hair color, color of eyes, complexion and the like. For instance, the personal mannequin image may not be to-scale and/or may not exactly or, in another implementation, closely, replicate the precision numerical measurements and/or details such as hair color, color of eyes, complexion and the like.

The database 46 is accessible to the server 20 and, consequently, additionally, and/or alternatively, may be accessible to the client computers 80. The database 46 may contain a plurality of records, at least one of which may include information according to the customer.

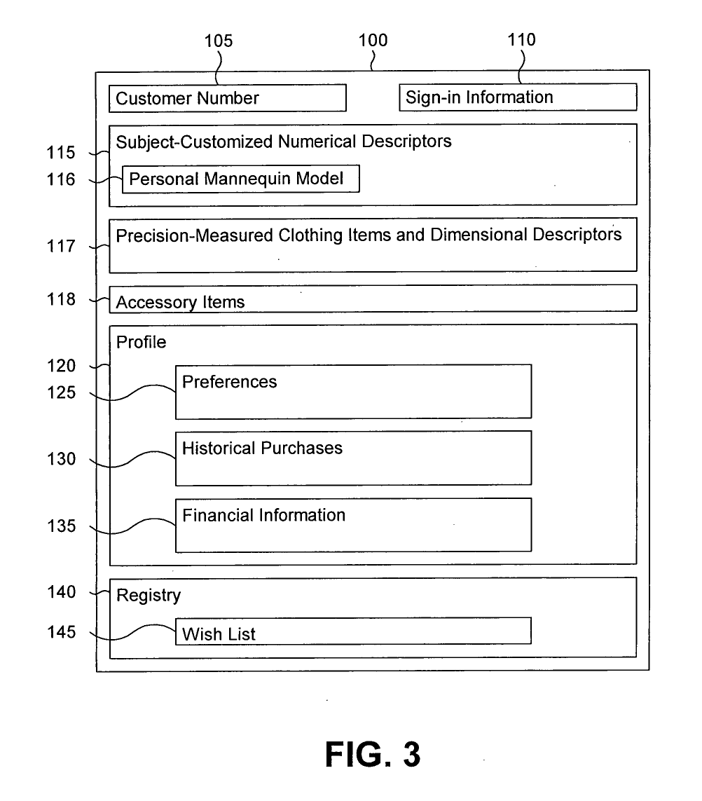

FIG. 3 is a conceptual diagram of an example of a file 100 that may be created and maintained in the database 46 by the server 20 (FIG. 2) according to data received from a customer. The illustrated example includes a field 105 for a customer number that may identify the customer along with a sign-in field 110 containing a user name, password, and the like. The database 46, further, may comprise (1) a record or records of subject-customized numerical descriptors 115, the record(s) of subject-customized numerical descriptors 115 potentially comprising sets (e.g., vectors) of precision numerical measurements describing all or part of a body of a subject (who may be a user, customer, and the like), and (2) vectors associated with various items of clothing.

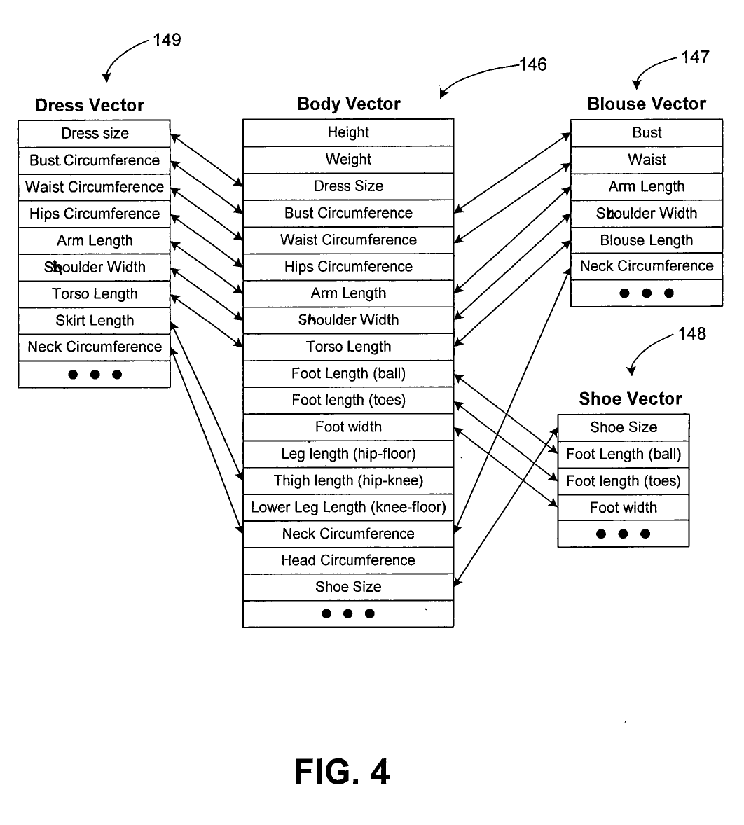

FIG. 4 illustrates one example of a body vector 146 corresponding to an adult female subject, the body vector comprising measurements such as height, weight, bust circumference, waist circumference, hip circumference, arm length, circumference modeling measurements, point-to-point modeling measurements, and so on, taken from the body of the subject. As such, the body vector 146 is a collection of subject-customized numerical descriptors describing at least a portion of the body of the subject. Typically, the body vector 146 is constructed according to input data received from a user (e.g., customer), the input data comprising measurements such as those listed above. The body vector 146 may be stored, according to one illustrative example, in the record of subject-customized numerical descriptors 115 described supra with reference to FIG. 3.

The file 100 (FIG. 3) further may comprise a plurality of records related to a plurality of precision-measured clothing items, each of which may be described by a clothing vector comprising detailed dimensional descriptors unique to that precision-measured clothing item. Examples of clothing vectors, including, for example, a blouse vector 147, comprising numerical descriptors appropriate to a particular blouse such as bust circumference, waist circumference, arm length, circumference modeling measurements, point-to-point modeling measurements, and so on, are illustrated in FIG. 4. Similarly, a shoe vector 148, and a dress vector 149 are illustrated, which vectors may contain numerical descriptors appropriate to, respectively, a particular pair of shoes and a particular dress. The dress vector 149 may include such measurements as torso length, shoulder width, skirt length, circumference modeling measurements, point-to-point modeling measurements, and so on. The shoe vector may contain, in addition to shoe size, a first measure of foot length measured from a heel to a ball of a foot, a second measure of foot length measured from the heel to a farthest tip of a toe, a foot width measured across the ball of the foot, circumference modeling measurements, point-to-point modeling measurements, and so on. Clothing having associated therewith clothing vectors of a type just described may be referred to as precision-measured clothing.

Of course, it is understood that body vectors for men, women, boys and girls of various ages, etc. may be qualitatively different. Accounting for differences associated with sex, age, and the like, is within the spirit of the present disclosure.

The file 100 of FIG. 3, also may comprise a personal mannequin model record 116 that may include data comprising, for example, body vector information as illustrated in FIG. 4 and as described supra, which information may be sufficient to display an image (e.g., a 3-D image that may be, for example, rotatable and/or positioned/transitioned through different movements or poses) of the personal mannequin model.

The file 100 still further may comprise a plurality of records 117 corresponding to precision-measured clothing items. The plurality of records 117 may comprise, for example, a plurality of graphic images according to precision-measured clothing items in addition to corresponding clothing vectors associated with each precision-measured clothing item. A plurality of accessory item records 118, further, may be included, which records may contain, for example, graphical images of accessory items such as handbags, jewelry, scarves, belts and the like, which may be displayed with the image of the personal mannequin. According to one embodiment, some or all of the accessory items are precision-measured clothing items. Additionally, customer profile record 120 may contain, for example, fields for storing personal preferences 125, a list of historical purchases 130, and/or financial information 135. Alternative embodiments of the customer profile record 120 may, further, comprise a list of materials to which the user may have a particular affinity or aversion. For example, the customer profile record 120 may comprise a list of materials to which the user may have contact allergy. A current wardrobe of the customer may also be included in the customer profile record 120, thereby enabling a search for coordinated pieces from manufacturers. Thus, as an example, label information from wardrobe items may be included in the customer profile record 120. With the wardrobe information, the user may contact a manufacturer to inquire whether a wardrobe item is in the manufacturer's inventory. In response, the manufacturer may, for example, email coordinated suggestions regarding information in the customer's personal mannequin (e.g., virtual mannequin). The file 100, further, may comprise a registry area 140 in which is maintained a list 145 that may include desired items according to the customer.

In one example, a third party (e.g., a friend or relative of the customer) may operate a computer, for example, one of the client computers 80, to access the registry 140 and may identify (e.g., select) desired items in the list 145 (e.g., precision-measured clothing items, accessories, and the like). The third party may place an on-line order, which may be received by the server 20. The server 20 may update the list 145 according to the order. Of course, the customer also may purchase items on-line by placing an order that may be, likewise, received by the server 20, which may update the list 145 accordingly.

According to a typical embodiment of the server 20 illustrated in FIG. 2, the modeling software module 60 may cause the processor 25 to access or update an existing set of clothing vectors, which may be stored, for example, in a plurality of precision-measured clothing item and/or dimensional descriptor records 117. If such a vector(s) does not already exist, then the modeling software module 60 may cause the processor to generate such a vector. In either case, the modeling software module 60 effectuates the accessing, updating, and/or generating of a set of clothing vectors.

According to an aspect of the present invention, the server 20 may transmit the image (e.g., or information sufficient for generation of the image) of the personal mannequin model to the client computer where the client computer may present the image of the personal mannequin model to the user on a customary display screen that may form a portion of the client computer. Alternatively, or additionally, for example, the unique physical dimensions and measurements may be transmitted to the user for verification in lieu of, or in addition to, transmitting the image of the personal mannequin.

The server 20, further, may transmit one or more of a plurality of images of precision-measured clothing items, precision measurements of the clothing, including, for example, information in a clothing vector of a type illustrated in or described in connection with FIG. 4, in addition to common designations of “small,” “medium,” “large” and so on.

The user may select one of the plurality of images, which selection may be received by the server 20. The server 20 then may create an image of the personal mannequin dressed in the selected precision-measured clothing item and may transmit the image to the client computer for display to the customer. When a user selects a particular item of clothing, the modeling software module 60 (FIG. 3) may, according to one embodiment, cause the processor 25 to retrieve from the database 46 a vector according to the selected clothing item, and may, further, perform comparisons of (a) multiple components (e.g., at least five components) of a body vector associated with the user and (b) corresponding components of a clothing vector associated with the selected clothing item.

The comparisons may allow the processor 25 to determine an exactness-of-fit of the clothing item to the body of the user. For example, when considering a dress described by dress vector 149 (FIG. 4) for a user having a body vector 146, the modeling software module 60 may cause the processor 25 to compare numbers for dress size in the two vectors, numbers for bust in the two vectors, and so on. The comparisons may permit the server 20 to communicate to the user on one of the client computers 80 that the dress is “too baggy in the waist,” “too short in the arms,” “too tight across the shoulders,” and so on. Such communication to the user may or may not involve transmitting an image of the personal mannequin.

Each personal mannequin, clothed with one or more items, can be saved, printed, forwarded by email to a third party, and/or retrieved later and modified by the user. Furthermore, multiple saved personal mannequins may be generated or retrieved, and compared side-by-side by the user.

According to one exemplary embodiment, the server may further be adapted to emphasize areas on the personal mannequin image where a fit may be unsatisfactory to the customer. For example, a sleeves of a shirt may be too tight near the left elbow, a blouse may be too long in the neck, a jacket may bunch in the back, and so on. Such a potential problem area of fit may be highlighted, for example, by color, flashing the problem area, superimposing an arrow on the image pointing to the problem area, or the like.

In addition to precision-measured clothing, accessories such as shoes, handbags, jewelry, scarves, belts, alternative hair styles, and the like, may be offered on-line. Modified embodiments may offer similar accessories in different colors that suit a profile of the customer. That is, the server 20 may transmit images of a plurality of accessories from which a customer may make a selection, which may be received by the server 20. The server 20 may, accordingly, adorn the personal mannequin with the accessories (along with any selected precision-measured clothing), may create a corresponding image, and may transmit the image to the client computer for display to the customer.

Some exactness-of-fit aspects of precision-measured clothing and accessories may not be fully apparent from a stationary image of the personal mannequin on a display screen of a client computer. Accordingly, the server 20 may receive commands, e.g., an orientation command, that may cause the server 20 to modify a stance or pose of the imaged personal mannequin with any associated clothing and accessories and to transmit the modified image to the client computer for display. For example, the orientation command may request that the personal mannequin rotate slowly so that front, side, and rear views of a selected configuration can be observed. Such views may be described as 360-degree virtual rotating views of a virtual mannequin, in modified embodiments. Other orientation commands may request that the personal mannequin walk normally, jog, raise an arm, bend over, twist, sit down, wave, extend an arm to shake a hand, reach into a cabinet, stand on tip-toe while reaching overhead, and so forth. Raising an arm may, for example, expose an area of tight fit in the shoulder, which tight fit might be communicated to the user by the server 20 as described supra.

According to another embodiment, an orientation command may request that an image of the personal mannequin walking normally be presented, and a fit of, for example, shoes displayed on the personal mannequin be analyzed by the server 20. For example, the server 20 may compare elements of a body vector 146 with corresponding elements of a shoe vector 148, which comparison may identify one or more areas of pressure points on feet, which pressure points may be emphasized on an image of the personal mannequin displayed on the client computer screen. Alternatively, the server 20 may simply communicate information of a form of “shoe too long,” “shoe rubs on toes when walking,” or the like to the user on the client computer.

In this or any of the other described examples or embodiments, actual vector-comparison information may be communicated to the customer, additionally, or instead.

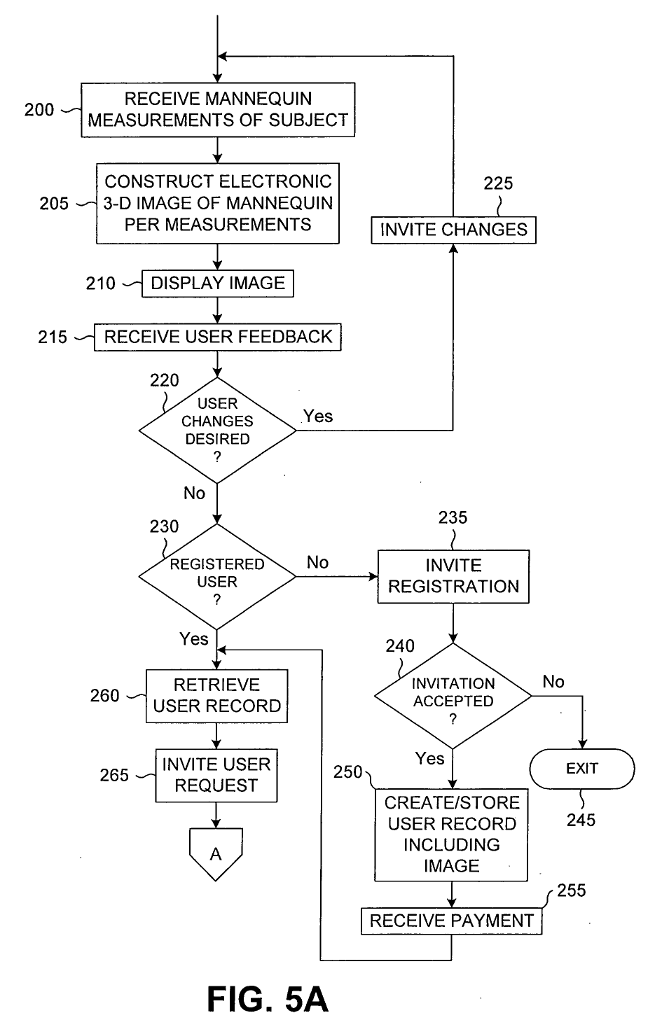

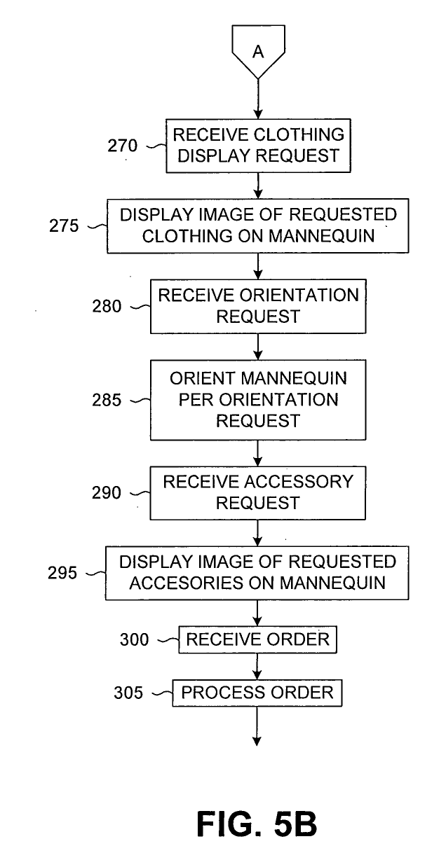

An aspect of the present invention is elucidated with the aid of a flow chart as provided in FIGS. 5A and 5B. The illustrated flow chart represents one particular implementation of a method comprising receiving at step 200 a plurality of properties that describe a personal mannequin. Typically, the properties comprise measurements such as height, weight, and the like, made on a human subject, and further include measurements that are much more detailed than is customary to describe (a) a recipient of off-the-shelf and/or pre-manufactured clothing or (b) such clothing items. Examples of such measurements may comprise those contained in a body vector such as the body vector 146 described supra and depicted in FIG. 4.

The subject may or may not be a customer or a registered user of services offered by, for example, a business entity employing a server such as the server 20 likewise described supra with regard to FIG. 2. For example, the subject may be a child or a partner of a registered user. According to one implementation, the user is not necessarily registered.

A model, (e.g., a three-dimensional electronic image) of a personal mannequin corresponding to the received measurements may be created at step 205 according to the plurality of properties received at step 200. For example, modeling software 60 stored in program memory 35 of the server 20 of FIG. 2 may cause the processor 25 of the server 20 to create the image. The image may be displayed at step 210, typically, by transmitting information pertaining to the image over a network such as the computer network 75 in FIG. 2 to one of a plurality of client computers 80 where the image can be visually observed by the user.

Step 200 is optional to the extent that such measurements may have been entered by earlier or different means. Steps 205 and/or 210 are optional in embodiments wherein an image is not used (in which embodiments step 250 and/or any one or more of steps 270-295, infra, may or may not be implemented and may or may not include an image), as would be apparent to one skilled in the art.

The user may provide feedback, which may be received at step 215 by, for example, a server such as server 20 in FIG. 2. If the user wishes to make changes to the personal mannequin model at step 220, then the user may be invited to submit changes at step 225, and the method may resume at step 200. According to an alternative implementation of the method described in FIGS. 5A and 5B, the user may submit desired changes in, for example, weight, measurements and the like to the personal mannequin by using email. In any case, the user may or may not incur a fee or cost when requested changes to the personal mannequin are made. When the user is satisfied with the personal mannequin at step 220, then a test may be made at step 230 to determine whether the user is registered. For example, the test may comprise the server 20 (FIG. 2) accessing a database, such as the database stored on the hard disk 45, to determine whether the user has a record extant in the database. If not, then the user may be invited to register at step 235 by transmitting an invitation message to the client computer where a graphical interface may present the invitation on the client computer display.

It should be noted that an unregistered user may be introduced to advantages of having a personal mannequin by observing the image produced by following the above method, which, therefore, may provide an incentive for the user to accept the invitation to register. In any case, if the invitation is accepted at step 240 (by clicking with a mouse, for example, on a YES indicator on a display screen of the client computer), then the method continues at step 250. Otherwise, the method terminates at step 245, and the personal mannequin model constructed for the user may be discarded.

When the user does accept the invitation to register at step 240, then a record according to the user may be created and stored at step 250. The record, a conceptual example of which is illustrated in FIG. 3, may include numerical descriptors 115 personalized to the user. The descriptors, further, may be sufficient to display an image of the personal mannequin. As part of the registration process, payment may be received at step 255. For example, the user may pay on-line using a credit card, PayPal®, or other known method of on-line payment.

The user record may be retrieved at step 260, which step may follow step 230 in instances where the user has previously registered. The record may retrieved from a database such as the database 46 by, for example, the server 20 described supra with reference to FIG. 2.

The user may be invited to submit a clothing request, which may be received at step 265. Typically, this and other invitations issued according to the illustrated implementation of the method may take a form of a graphical image transmitted to a client computer by a server, the graphical image comprising a list of clothing items that may be selected, a collection of images of items, or the like. A user may submit a clothing request by making a selection at a client computer.

A request to display a particular clothing item, or an outfit formed by a plurality of clothing items, may be received at step 270. For example, the registered user may click with a mouse on an image of the clothing item on a display screen of a client computer, which may cause the client computer such as client computer 80A (FIG. 2) to transmit the request to a server such as, for example, the server 20 illustrated in FIG. 2, which may receive the request as input to an input port 41 from a computer network 75.

An image of the personal mannequin dressed according to the request may be displayed at step 275. As described supra with reference to FIG. 2, an orientation request may be received at 280 that may request, for example, that the personal mannequin walk, raise an arm, and the like, thereby orienting the mannequin according to the request at step 285.

When a user selects a particular item of clothing, a vector according to the selected clothing item is retrieved, and comparisons are performed between (a) multiple components (e.g., at least five components) of a body vector associated with the user and (b) corresponding components of the selected clothing vector associated with the selected clothing item.

The comparisons may allow the processor 25 to determine an exactness-of-fit of the clothing item to the body of the user. For example, when considering a dress described by dress vector 149 (FIG. 4) for a user having a body vector 146, the modeling software module 60 may cause the processor 25 to compare numbers for dress size in the two vectors, numbers for bust in the two vectors, and so on. The comparisons may permit the server 20 to communicate to the user on one of the client computers 80 that the dress is “too baggy in the waist,” “too short in the arms,” “too tight across the shoulders,” and so on. Such communication to the user may or may not involve transmitting an image of the personal mannequin.

According to one exemplary embodiment, the server may further be adapted to emphasize areas on the personal mannequin image where a fit may be unsatisfactory to the customer. For example, a sleeves of a shirt may be too tight near the left elbow, a blouse may be too long in the neck, a jacket may bunch in the back, and so on. Such a potential problem area of fit may be highlighted, for example, by color, flashing the problem area, superimposing an arrow on the image pointing to the problem area, or the like.

Regarding the comparisons performed between (a) multiple components (e.g., at least five components) of a body vector associated with the user and (b) corresponding components of the selected clothing vector associated with the selected clothing item, a typical comparison can entail the simple determination of differences between the components, and then the taking of the result (or the results) over or under a preset threshold for each difference and communicating it to the customer.

Now, for a more particular, simple example, if a few of the components of a body vector are three circumferential values of the subject's neck, taken at ½ inch intervals along the vertical length of the neck, and a nylon turtle neck item of clothing is selected, the three components of the body vector (e.g., 15.5″, 15.3″, 15.3″) are compared with the corresponding components of the turtle neck (e.g., 15″, 15.3″, 15.7″), and then the three differences (e.g., +0.5″, 0.0″, −0.4″) are determined and communicated to the customer by way of one or more of images and/or text. For best accuracy, the components of the body and clothing vectors should be taken from the exact same areas that match up when the clothing item is placed on the mannequin; that is points on the mannequin where the body component measurements were taken should line-up (e.g., be contacted by or be connected with) locations on the clothing item (i.e., where the clothing item measurements were taken) that will contact the corresponding points when the clothing item is mathematically placed on the mannequin.

For example, the three differences can be communicated to the user by way of text such as the values of +0.5″, 0.0″, −0.4, and/or can be the 2-D or 3-D images of the clothing on the mannequin, among others, or can be a statement that the top of the turtleneck is a bit tight, or, if tolerances are provided (either by the user or pre-set) then “fit” or “no fit” information may be provided. For example, if the tolerance level is 0.25″, then a “no fit” statement (and/or, for example, a red area on the 3-D image in the tight area) can be communicated to the customer.

Extrapolation may be performed (e.g., to generate new components) if one or more of the “points” do not match-up with the “locations.” Now, when the orientation or pose of the mannequin changes, those points and locations change, so that the exactness-of-fit will likely change.

In addition to clothing, an accessory request may be received at step 290, accessories including handbags, jewelry, scarves, belts, alternative hair styles, and the like. An image of the personal mannequin adorned according to any pending clothing request and the accessory request, if any, may be displayed at step 295.

It should be clear that many other possible scenarios of requesting and displaying are possible according to the present invention. For example, information may be displayed in text format (e.g., “the glove does not fit in the fingers’) in addition to or as an alternative to the 2-D or 3-D image of a personal mannequin.

In any case, once a customer has explored one or more possibilities, an order may be received at step 300, and the order processed at step 305. Processing the order may comprise known steps such as confirming delivery address, receiving payment, calculating shipping charges, and so on.

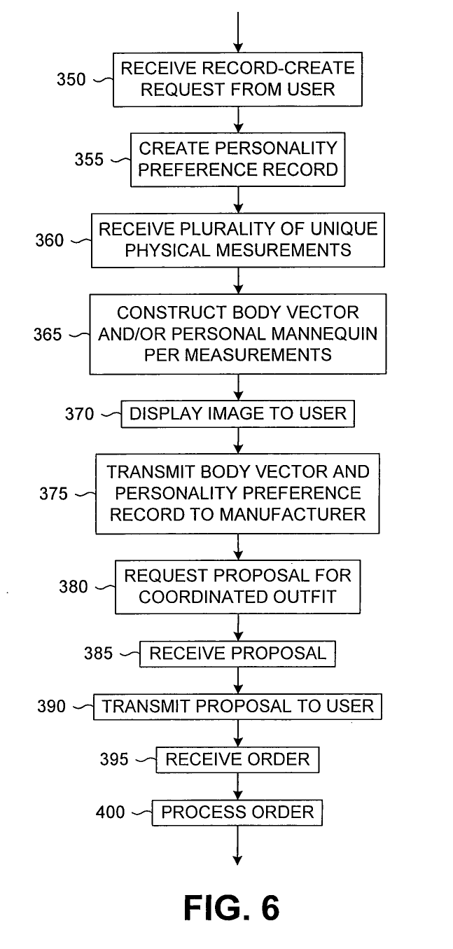

Yet another aspect of the present invention may take a form of an implementation illustrated as a flow chart in FIG. 6. The illustrated implementation comprises receiving a record-create request from a user at step 350. The record-create request may be received as input at an input 41, for example, by the server 20 illustrated in FIG. 2 when a user transmits a corresponding message from a client computer, e.g., client computer 80B.

In response to the record-create request, a personality preference record may be created at step 355. One implementation of the personality preference record may take a form similar to that shown in FIG. 3. A plurality of unique physical measurements may be received at step 360, the measurements typically being related to a user who submits the measurements on-line from a client computer such as one of the client computers 15 illustrated in FIG. 1. The measurements may have a precision quality as described supra relative to FIGS. 2, 3, and 4. A body vector of a type described supra with reference to FIG. 4 may be constructed according to the user's unique physical measurements at step 365. In an alternative implementation, a modeling software module, for example, the modeling software module 60 described supra with reference to FIG. 2, may cause a processor, e.g., processor 25 of a server 20 to create an image of a personal mannequin according to the body vector, and the image may be transmitted to the user for display at step 370.

A copy of the body vector and/or the image of the personal mannequin may be transmitted to a manufacturer along with a copy of the user's personal preference record at step 375, and a request for a proposal also may be sent to the manufacturer at step 380. According to one embodiment, a received proposal may comprise a recommendation. A modified embodiment comprises a step of receiving payment from a manufacturer of, for example, clothing, shoes, handbags and accessories, in exchange for providing the manufacturer with a program that enables the manufacturer to sell and/or advertise merchandise to the user by way of the facilities of the web-based virtual clothing coordinator. The request for proposal may ask, for example, that the manufacturer propose a coordinated outfit that may include, for example, precision-measured clothing and accessories according to the body vector and/or the personal mannequin and the personal preference record. A proposal may be received from the manufacturer at step 385 and the proposal transmitted to the user at step 390. Payment also may be received from the manufacturer in exchange for the opportunity to communicate with the user. An order for merchandize may be received from the user at step 395, and the order may be processed as described supra at step 400.

In accordance with the present invention, the web-based shopping methods described herein provide an opportunity for manufacturers to communicate directly with their customers at a reduced cost. The method and apparatus described also may overcome intimidation many feel when approached by over anxious sales persons in a store.

The methods described herein may be web-based and are completely interactive, so that a user (e.g., a customer) does not need assistance of a retail clothing sales employee in making personal decisions relating to applicability of certain clothing items. Rather, decisions can be made without interference in accordance with personal tastes and appearance of the customer. Moreover, the customer is free to move through information, provided on line by a server, such as the server 20 shown in FIG. 2, which information may comprise, for example, various video-presentation segments, at the customer's own pace and in accordance with the customer's own interests. As distinguished from some interactions with retail clothing sales employees, a customer may be less reluctant to engage and use the methods described herein, realizing that the customer does not have to be polite and can simply abandon an on-line session at any time should the customer lose interest.

In accordance with another important aspect of the present invention, an image of a personal mannequin constructed according to unique physical measurements of the customer may be displayed to the customer in privacy of a home or office. The user, further, may be allowed to alter the displayed image by simulating the application of various clothing items to the personal mannequin. The customer may employ a mouse, for example, on a normal computer display screen to select a category of clothing items, such as shirts, scarves, hats, etc. and, subsequently, may select a type of clothing from the selected category. The type may comprise a specific color and/or pattern, for example. Moreover, in a modified embodiment, the category may comprise a type of clothing, and the type may comprise a color and/or pattern of the clothing. In the case of clothing items, after having selected a category and a type, the customer then may select, with a mouse, for example, an area in his or her displayed image for simulating the application of the clothing to the personal mannequin.

The user may be provided with repeated opportunities to simulate application, removal, and re-application of clothing items to his or her personal mannequin on the display. The user, further, may save his or her personal mannequin, upon entering demographic and/or other data. In a typical embodiment, the user can, upon saving his or her personal mannequin, access an image of the personal mannequin and incorporate additional modifications thereto from a conventional personal computer, via the Internet. Furthermore, one or more versions of the personal mannequin, each clothed with one or more items, can be saved, printed, forwarded by email and/or retrieved later for comparison (e.g., the image(s) compared with an image(s) of another version(s) of the personal mannequin).

Upon completing the modifications to his or her image on the computer display, the user may be provided with an option to finalize his or her image. An itemized price list of the goods applied to the customer's image may be transmitted to the client computer for display to the customer, and the customer may be provided with an opportunity to purchase any one or more of the displayed items. The displayed items listed in the price listing typically are available for immediate shipping, so that the customer can promptly receive the purchased goods. Additionally, the customer may be provided an opportunity to learn more about one or more of the displayed items by selecting the item and viewing additional informative video presentations relating to the item.

According to another embodiment, customers can maneuver through the series of dynamic video-presentation screens of the web-based methods and apparatus described herein, more conveniently, in some aspects, than thumbing through a standard paper brochure. The user simply accesses an appropriate web site and makes selections on a computer display screen as directed to move forward and back, and to even repeat or skip information. In particular, organization and content of the information may be constructed to provide quick and convenient access to information that the customer most commonly asks retail clothing sales employees. With just a click of a mouse, the user of methods and apparatus described herein can: learn more about a retail product provider; learn more about recent product introductions; search products and services; view dynamic “virtual commercials”; purchase products; receive printouts of receipts, information, coupons, and/or order forms; and apply images of color clothing to their own image. These methods and apparatus further offer the following features and benefits: technical information on clothing issues including coordination aesthetics, color and clothing artistry; commonly asked questions and answers; common clothing problems and solutions; product recommendations; and leading clothing editorials. Other advantages may include, for example, manufactures, retailers, or distributors (a) not having to keep large inventories of products on-hand, on-site, or on shelves, which can save costs associated with generating or acquiring clothing which ends-up not being sold or sold at a discount and (b) being able to conveniently and accurately track inventory, based upon sales made by users as described herein, wherein future orders can be made for clothing items based upon prior sales.

Use of these methods and apparatus is expected to increase sales due to improved customer product knowledge and increased convenience to the customer. These methods and apparatus, further, allow collection of important and valuable demographic information on customers who use services provided thereby.

Various advantages of the present invention will readily become apparent to one skilled in the art. For example, a user can input a calendar of different occasions, events, parties, etc. at which a coordinated outfit may be required, thereby avoiding last minute shopping frustrations. According to a modified embodiment, an email may be sent to favorite designers and/or manufacturers requesting suggestions and/or recommendations of clothing and/or accessories The personal mannequin is available on-line at any hour of the day or night. Use of the web-based virtual clothing coordinator can save frustration of shopping on line after normal business hours, given that a customer can view and make choices before ordering, purchasing, or requesting shipment of an item, thereby reducing or avoiding a need to return purchased items. Additionally, time and fuel may be saved by using the web-based clothing coordinator when compared with visiting various stores in person looking for an outfit or for accessories that coordinate with an outfit. The convenience of visualizing a coordinated outfit on a personal mannequin rather than seeing the outfit in a brochure or magazine or a mannequin at a store may be a strong advantage to the user. According to one embodiment, orders can be delivered by mail. Alternatively, a user may email a local store requesting that a coordinated pre-selected outfit be prepared, and the user may pick up the outfit at the store. If desired, the user may try on the outfit at the store in order to confirm a choice made on-line. A user can contact a favorite manufacturer for specific clothes, shoes, etc., requesting to be notified when the items go on sale. The user can receive notification (e.g., email) from manufacturers regarding upcoming styles for fall-winter-spring-summer, etc. The user thereby may have first choice and be first informed on upcoming styles or trends. Still other embodiments may relieve shoppers of any reservations about shopping, given that no one sees their weight, height, or size.

An entity that offers the web-based virtual clothing coordinator including the personal mannequin may receive revenue from various activities associated therewith. For example, the entity may charge the user a membership fee (e.g., an annual fee) per personal mannequin. The entity may charge a manufacturer a fee for membership. The manufacturer may be charged for a percentage of all sales generated by the web-based virtual clothing coordinator. A customer (e.g., member) may be charged for every modification of his/her personal mannequin.

In view of the foregoing, it will be understood by those skilled in the art that the methods of the present invention can facilitate convenient on-line shopping for clothing and similar personal items. The above-described embodiments have been provided by way of example, and the present invention is not limited to these examples. Multiple variations and modification to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein.

For example, such a skilled artisan will immediately envision additional functionalities suggested by the description provided herein. For example, a user may select an area of a personal mannequin and then select one of several options for modification of a clothing item on the personal mannequin such as increase/decrease, raise/lower, change color, and the like.

The user may even request modifications to the personal mannequin, the modifications representing, for example, a result of contemplated plastic surgery to change an appearance of the user, not just the appearance of the personal mannequin. Indeed, a copy of the personal mannequin could be forwarded, along with an appropriate request, to a plastic surgeon, who may respond with a proposal/price quote for surgery according to the request.

As iterated above, any feature or combination of features described and referenced herein are included within the scope of the present invention provided that the features included in any such combination are not mutually inconsistent as will be apparent from the context, this specification, and the knowledge of one of ordinary skill in the art. For example, any of the components, and any particulars or features thereof, or other features, including method steps and techniques, may be used with any other structure and process described or referenced herein, in whole or in part, in any combination or permutation. Accordingly, the present invention is not intended to be limited by the disclosed embodiments, but is to be defined by reference to the appended claims.

What is claimed is:

1. A web-based virtual clothing coordinator, comprising:
an input adapted to receive input data through a computer network from at least one customer operating a client computer;
modeling software adapted to effectuate accessing, updating or generating a first vector of subject-customized numerical descriptors describing at least a portion of a body of a subject, the first vector being constructed according to the input data received from the customer, wherein the input data includes a plurality of precision numerical measurements taken from the body of the subject;
a database accessible to the client computer, the database comprising a plurality of records, each of the records corresponding to a precision-measured clothing item and comprising a second vector of detailed dimensional descriptors that is unique to that precision-measured clothing item;
a server configured to receive from the customer a selection of one of the precision-measured clothing items, the selected precision-measured clothing item being described by one of the second vectors of detailed dimensional descriptors that is unique to that selected precision-measured clothing item, and the server being configured to generate information describing an exactness-of-fit of the selected precision-measured clothing item to a portion of the body of the subject on which the selected precision-measured clothing item is designed to fit, the information being generated according to a comparison of a plurality of subject-customized numerical descriptors of the first vector to a corresponding plurality of the detailed dimensional descriptors of the second vector.

2. The apparatus as set forth in claim 1, wherein:
the plurality of subject-customized numerical descriptors comprises five or more subject-customized numerical descriptors;
the plurality of detailed dimensional descriptors comprises five or more detailed dimensional descriptors; and
the modeling software is adapted to effectuate presentation on the client computer of an electronic image of a personal mannequin corresponding to the subject, based upon the input data.

3. The apparatus as set forth in claim 2, wherein:
the plurality of records is a first plurality of records;
the database further comprises a second plurality of records, each of the second plurality of records containing an image of an accessory item; and
the server is further adapted to:
receive from the customer a selection of at least one of the accessory items; and
transmit an image of the personal mannequin outfitted with the at least one of the accessory items according to the selection.

4. The apparatus as set forth in claim 3, wherein the server is further adapted to:
receive an orientation command; and
modify an image of the personal mannequin according to the orientation command.

5. The apparatus as set forth in claim 3, further comprising a third plurality of records including at least one record containing a customer profile, the customer profile comprising:
a list of preferences according to the customer;
a historical list of customer purchases; and
financial information according to the customer.

6. The apparatus as set forth in claim 1, wherein the server is configured to:
receive an orientation command;
form a comparison of at least a portion of the subject-customized numerical descriptors taken from the first vector and a corresponding portion of detailed dimensional descriptors taken from the second vector;
make an exactness-of-fit determination according to the comparison; and
communicate at least one area on the image according to the determination.

7. A method, comprising:
receiving through a computer network from a user operating a client computer a first vector comprising a plurality of subject-customized numerical descriptors describing at least a portion of a body of a subject;
constructing an electronic image of a personal mannequin according to the first vector;
presenting on the client computer a plurality of images of precision-measured clothing items, each precision-measured clothing item being described by a second vector comprising a plurality of detailed dimensional descriptors that are unique to that precision-measured clothing item;
receiving a selection of at least one precision-measured clothing item;
comparing subject-customized numerical descriptors of the first vector to detailed dimensional descriptors of the second vector; and
displaying on the client computer an electronic image of the personal mannequin dressed with the at least one clothing item.

8. The method as set forth in claim 7, wherein:
the plurality of subject-customized numerical descriptors comprises five or more subject-customized numerical descriptors; and
the plurality of detailed dimensional descriptors comprises five or more detailed dimensional descriptors.

9. The method as set forth in claim 8, further comprising:
receiving an orientation command;
forming a comparison of at least a portion of the subject-customized numerical descriptors taken from the first vector with a corresponding portion of detailed dimensional descriptors taken from the second vector;
making an exactness-of-fit determination according to the comparison; and
identifying at least one area on the image according to the determination.

10. The method as set forth in claim 8,
wherein the identifying comprises highlighting.

11. The method as set forth in claim 10, further comprising:
receiving an order for merchandise according to the presenting of the image; and
processing the order.

12. The method as set forth in claim 8, further comprising:
receiving an electronic image of a portion of the body of the subject; and
incorporating the image of the body portion into image of the personal mannequin.

13. The method as set forth in claim 8, further comprising:
receiving a request for at least one change to the personal mannequin model; and
incorporating the requested change into the model.

14. A method, comprising:
receiving a record-create request through a computer network from a user operating a client computer;
creating a personality preference record for the user according to the record-create request and according to answers received from the user to questions presented to the user;
receiving at least five unique physical measurements taken from the body of the user;
constructing an electronic image of a personal mannequin according to the unique physical measurements; and
displaying the image to the user.

15. The method as set forth in claim 14, further comprising:
inviting the user to submit modifications to the image;
receiving a submission from the user, the submission including modifications to the plurality of unique physical measurements;
modifying the image according to a submission received from the user;
including the modified image in the personality preference record; and
inviting the user to register as a customer when the user is not already a customer.

16. The method as set forth in claim 15, further comprising:
receiving a payment from the user when the user registers as a customer; and
storing the personality preference record in a database when the user is a customer.

17. The method as set forth in claim 16, further comprising:
displaying a plurality of images of precision-measured clothing to the user when the user is a customer;
receiving a selection of precision-measured clothing from the customer; and
displaying to the customer an image of the personal mannequin wearing the selection of precision-measured clothing, thereby displaying an image of the mannequin wearing the precision-measured clothing.

18. The method as set forth in claim 17, further comprising:
transmitting to at least one manufacturer the plurality of unique physical measurements and a representation of the personal preference record;
receiving payment from the manufacturer in exchange for the transmitting;
requesting a proposal for a coordinated outfit of at least one of an item of precision-measured clothing and an accessory item according to the plurality of unique physical measurements and the personal preference record;
receiving a proposal according to the request; and
transmitting the proposal to the customer.

19. The method as set forth in claim 18, further comprising displaying to the customer an image of the personal mannequin adorned in the coordinated outfit.

20. The method as set forth in claim 18, further comprising:
receiving an order to purchase one or more of an item of clothing and an accessory item; and
processing the order.
